(19) United States
(12) Patent Application Publication
(10) Pub. No.: US 2026/0110645 A1
(43) Pub. Date: Apr. 23, 2026

(54) X-RAY INSPECTION APPARATUS

(71) Applicant: ANRITSU CORPORATION, Kanagawa (JP)

(72) Inventors: Takashi KANAI, Kanagawa (JP); Naoya SAITO, Kanagawa (JP)

(21) Appl. No.: 19/357,740

(22) Filed: Oct. 14, 2025

(30) Foreign Application Priority Data
Oct. 21, 2024 (JP) 2024-185052

(51) Int. Cl. G01N 23/04; G01N 23/083; G06T 7/00; H04N 25/30

(52) U.S. Cl. CPC G01N 23/04; G01N 23/083; G06T 7/0012; G01N 2223/3308; G01N 2223/401; G01N 2223/505; G06T 2207/10116; H04N 25/30

(57) ABSTRACT

An X-ray inspection apparatus includes: an X-ray generator that irradiates an inspection object with X-rays; an X-ray detector that outputs detection data for each of a plurality of line sensors disposed in a transport direction; an image generation unit that generates an inspection image including a plurality of pixels each having a density value based on the detection data; and an inspection processing unit that inspects a quality of the inspection object based on the inspection image, in which the X-ray detector includes a scintillator having good afterglow characteristics, and the line sensor including CMOS type photoelectric sensors that output the detection data, and the image generation unit generates the inspection image based on light reception data obtained by integrating the detection data output by the X-ray detector by a TDI method.

### TECHNICAL FIELD

The present invention relates to an X-ray inspection apparatus, and particularly to an X-ray inspection apparatus that inspects a quality of an inspection object such as food or a medicine based on X-ray image data.

### BACKGROUND ART

As an X-ray inspection apparatus that inspects a quality of an article orally ingested, such as food or a medicine, for example, the presence or absence of contained foreign matter or missing items, and the presence or absence of a defect in the form of a main portion such as a content or a seal portion, an X-ray inspection apparatus that irradiates the article being transported with X-rays, detects the transmitted X-rays by a periodic detection operation of a line sensor to acquire two-dimensional image data, and inspects the quality of the inspection object based on a result of predetermined image processing on the image data has been known.

In such an X-ray inspection apparatus, X-ray outputs from an X-ray generator are set as X-ray tube voltage and X-ray tube current for each article type of the inspection object so that a density distribution and a contrast of the X-ray image are appropriate in accordance with a thickness, a transport speed, or the like of the inspection object.

As this type of X-ray inspection apparatus in the related art, for example, there is an X-ray inspection apparatus that stores a setting-time X-ray image associated with article type information of an inspection object in a memory in a form of a compressed image or the like and makes it possible to accurately and easily determine an inspection condition of the article type to be selected in a case of selecting the article type. In this apparatus, operation conditions of X-ray detection means and an X-ray image generation unit are set for each article type of the inspection object, and the X-ray image generated by the X-ray image generation unit is stored as the setting-time X-ray image information in association with setting information for each article type (for example, see Patent Document 1).

In addition, in order to solve a problem in which, in a case where the X-ray outputs of the X-ray generator are reduced, detection outputs of an X-ray detector are reduced, and it is difficult to detect the foreign matter with high sensitivity, and it is difficult to perform the X-ray inspection with high sensitivity, a technique of improving the X-ray detection sensitivity and reducing the X-ray outputs by synthesizing and outputting detection data from the X-ray detector by a time delay integration (TDI) method has been known (for example, see Patent Document 2).

### RELATED ART DOCUMENT

### Patent Document

[Patent Document 1] JP-A-2007-232586
[Patent Document 2] JP-A-2011-242374

### DISCLOSURE OF THE INVENTION

### Problem that the Invention is to Solve

However, in the X-ray inspection apparatus as described above, there is an increasing demand for energy saving and long life in addition to the improvement in the inspection performance, and thus the following issues have become apparent.

That is, in a case where the X-ray generator is made to have low outputs in order to increase the article transport speed to meet the demand for improvement in productivity and to meet the demand for energy saving, miniaturization, and long life, an output level of a detection signal of an X-ray line sensor is further reduced, and a density resolution of the X-ray image is deteriorated.

In addition, in a case of an indirect conversion type X-ray detector, afterglow of the scintillator overlaps a detection signal of a next period (next scanning period) of the line sensor in a scanning period of the line sensor corresponding to the increase in the transport speed, and the image is blurred, which causes a problem in that a spatial resolution of the X-ray image is deteriorated.

In contrast, in addition to employing a TDI-method line scan camera including a plurality of line sensor arrays in the X-ray detector to increase the detection sensitivity, it is considered to adopt a CMOS sensor suitable for reducing power consumption and size of the X-ray inspection apparatus in the line scan camera to meet the demand for high speed inspection with low power consumption.

However, even in a case where the CMOS sensor is simply employed in the line scan camera, in the X-ray inspection apparatus that inspects the quality of food or the like, there is an issue of insufficient light amount of a scintillator due to the variety of the article type, the thickness, the packaging form, and the like, and it is necessary to use a scintillator having a large light emission amount instead of a scintillator having a small light emission amount and a short afterglow time. Therefore, even though noise reduction is achieved by the TDI method, there is an unresolved issue in that the X-ray image is blurred and the detection sensitivity is likely to be lowered due to a low temporal resolution of the detection data of the line scan camera.

Therefore, an object of the present invention is to provide an X-ray inspection apparatus that can execute satisfactory inspection while increasing an article transport speed and reducing outputs of an X-ray generator.

### Means for Solving the Problem

(1) In order to achieve the above-described object, one embodiment of the present invention provides an X-ray inspection apparatus including: an X-ray generator that irradiates an inspection object passing through a transport path with X-rays; an X-ray detector that includes a plurality of line sensors arranged in a transport direction of the inspection object and each including a plurality of detection elements linearly disposed in a main scanning direction perpendicular to the transport direction and that outputs detection data obtained from each detection element for each stage of the plurality of line sensors; an image generation unit that generates an inspection image including a plurality of pixels each having a density value based on the detection data output by the X-ray detector; and an inspection processing unit that inspects a quality of the inspection object based on the inspection image, in which the X-ray detector includes a scintillator that detects the X-rays and that has good afterglow characteristics, the plurality of detection elements are CMOS type photoelectric sensors that output the detection data by receiving light emitted in response to the X-rays detected by the scintillator, and the image generation unit generates the inspection image based on light reception data obtained by integrating the detection data of the plurality of line sensors by a TDI method.

With this configuration, in the present invention, an optical image from the scintillator that detects the X-rays and that has good afterglow characteristics is photoelectrically converted by the CMOS type photoelectric sensor, and the detection data of the detection element arrays (line sensors) in a plurality of stages of the X-ray detector is obtained, the detection data is integrated by the TDI method to obtain imaging data, and the inspection image is generated based on the imaging data. In addition, during the generation of the inspection image, the occurrence of blurriness in the inspection image obtained from the imaging data of the detection element arrays in a plurality of stages is effectively suppressed by the action of the scintillator having good afterglow characteristics in which a predetermined light emission amount is obtained within the scanning period of the detection element array of each stage and the afterglow characteristics are shortened to the extent that the afterglow does not overlap with the detection signal of the next period of the detection element array of each stage. Therefore, in addition to the generation of the inspection image with low noise even in the high transport speed range by the TDI-method imaging in which the CMOS sensor is adopted, improvement in a temporal resolution of scintillation light effectively suppresses the blurriness of the X-ray image, and required detection sensitivity is ensured, so that satisfactory X-ray inspection can be executed.

Here, the expression “good afterglow characteristics” means that the light emission amount (brightness) of the scintillator is obtained to the extent that the inspection image can be generated with low noise even in a high transport speed range by the TDI-method imaging, and an attenuation time (damping time constant) of the light emission intensity of the scintillator is sufficiently shorter than the scanning period of the detection element array of each stage of the X-ray detector, preferably means that the attenuation time is shorter than the scanning period of the detection element array of each stage of the X-ray detector during high-speed transport, and particularly preferably means that the attenuation time is half or less of the scanning period of the detection element array of each stage of the X-ray detector during high-speed transport.

(2) In the preferred embodiment of the present invention, the X-ray inspection apparatus may include: inspection condition detection means for detecting that a specific inspection condition that causes degradation in an image quality of the inspection image is established; and image data adjustment means for adjusting the detection data output from the X-ray detector so that the image quality of the inspection image is improved, in a case where the inspection condition detection means detects that the specific inspection condition is established, in which the image generation unit generates an inspection image with an expanded range of the density value based on adjusted detection data that is adjusted by the image data adjustment means, and the inspection processing unit executes the inspection based on data of the inspection image with the expanded range of the density value.

In this case, by expanding the range of the density value of the inspection image by binning processing or kernel processing, it is possible to execute the image reduction while suppressing the loss of information due to the thinning out of the pixels, and even in a case where the article transport speed is increased or the outputs of the X-ray generator are reduced as described above, it is possible to effectively suppress the influence of the decrease in the signal level of the detection signal, and to execute satisfactory inspection processing.

(3) In the preferred embodiment of the present invention, the specific inspection condition may include a condition in which a transport speed of the inspection object passing through a predetermined section on the transport path reaches or exceeds a predetermined speed, or a condition in which an irradiation intensity of the X-rays emitted from the X-ray generator to the inspection object is decreased to be less than a predetermined intensity.

In this case, in a case where the specific inspection condition causes the degradation in the image quality of the inspection image, the detection data output from the X-ray detector is adjusted so that the image quality of the inspection image is improved. Therefore, it is possible to ensure a required image quality of the inspection image and to execute satisfactory inspection processing.

(4) In the preferred embodiment of the present invention, the X-ray inspection apparatus may further include: height setting means for setting a reference height from a transport surface of the transport path; and scanning condition setting means for setting a scan period in the main scanning direction of the X-ray detector and a delay time in the transport direction so that an aspect ratio on a transmission image at the reference height becomes 1.

In this case, the scan period in the main scanning direction of the X-ray detector and the delay time for the TDI-method integration processing are variably set so that the aspect ratio on the transmission image at the reference height becomes 1. Therefore, the resolution in each coordinate axis direction of the two-dimensional inspection image is evenly obtained, and the effect of the time delay integration (TDI) method is accurately obtained.

(5) In the preferred embodiment of the present invention, the X-ray inspection apparatus may further include: storage means for storing the reference height set by the height setting means for each article type of the inspection object. In this case, a suitable reference height for each article type, for example, a center height or a centroid height can be set, and a time taken for each portion of a plane cross-sectional region at the reference height to pass between the detection element array on a front stage side and the detection element array on a rear stage side adjacent to each other in the transport direction can be set as the delay time in the transport direction for the TDI-method integration processing.

### Advantage of the Invention

According to the present invention, it is possible to provide the X-ray inspection apparatus that can execute satisfactory inspection by combining the scintillator having good afterglow characteristics such that the afterglow does not overlap with the detection signal of the next period of the line sensor and the CMOS sensor suitable for reducing power consumption, and ensuring the required detection sensitivity by the TDI-method X-ray detection, while increasing the article transport speed and reducing the outputs of the X-ray generator.

### BRIEF DESCRIPTION OF THE DRAWINGS

FIG. 1 is a schematic configuration diagram of an X-ray inspection apparatus according to one embodiment of the present invention.

FIGS. 2A to 2C are configuration diagrams of an X-ray detection unit in the X-ray inspection apparatus according to the embodiment of the present invention, in which FIG. 2A is an explanatory diagram of the disposition of an X-ray generator and an X-ray detector spaced apart from each other above and below a transport surface, FIG. 2B is a front view of a main portion of the X-ray generator when viewed in a Y direction (main scanning direction) in FIG. 2A, and FIG. 2C is a front view of a main portion showing another aspect of the X-ray generator.

FIG. 3 is an explanatory diagram of TDI-method imaging data processing in the X-ray detector including a CMOS type photoelectric sensor in the X-ray inspection apparatus according to the embodiment of the present invention.

FIG. 4 is an explanatory diagram of binning processing of X-ray image data executed in accordance with an inspection object transport speed in the X-ray inspection apparatus according to the embodiment of the present invention.

### BEST MODE FOR CARRYING OUT THE INVENTION

Hereinafter, an embodiment according to the present invention will be described with reference to the accompanying drawings.

### One Embodiment

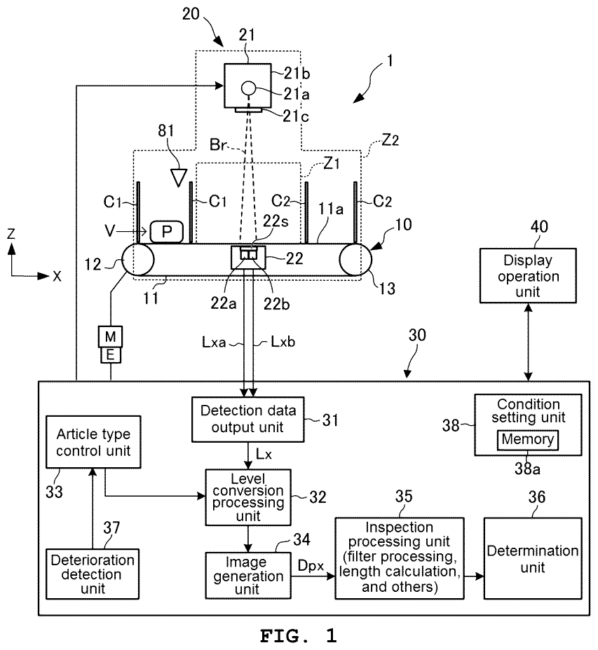

FIGS. 1 to 4 are diagrams showing an X-ray inspection apparatus according to one embodiment of the present invention.

First, a configuration will be described.

As shown in FIG. 1, an X-ray inspection apparatus 1 according to the embodiment of the present invention includes an article transport unit 10, an X-ray inspection unit 20, a control unit 30, and a display operation unit 40, and constitutes a part of an inspection system in which a sorting device (not shown) and the like are installed in a rear stage of the article transport unit 10.

The X-ray inspection apparatus 1 is an apparatus that executes inspection with X-rays, which are radiation classified as electromagnetic waves capable of being transmitted through an inspection object P, and has, for example, a foreign matter detection function of determining, with X-rays, whether or not foreign matter is contained in the inspection object P. However, the X-ray inspection apparatus 1 may have a function such as missing item inspection, mass inspection, inspection of a shape of the inspection object, such as a thickness, a length, packaging defect detection such as biting of the content into a seal portion, and the like, instead of the foreign matter detection. In addition, the present invention has a configuration in which a scintillator described later is used, and it goes without saying that the radiation classified as electromagnetic waves includes not only the X-rays but also other types of radiation for inspecting the article.

### Configuration of X-Ray Inspection Apparatus

In the article transport unit 10 of the X-ray inspection apparatus 1, a belt 11 is looped over a pair of rollers 12 and 13 parallel to each other, and the inspection object P can be transported in an X direction, which is a predetermined transport direction, through a transport path 11a, which is an upper running portion of the belt 11. In addition, the article transport unit 10 includes a transport drive motor M (not shown) that rotationally drives any of the rollers 12 and 13 at a variable set speed to move the belt 11 at a predetermined transport speed V, and an encoder E for detecting a rotation speed of the transport drive motor M. Further, the predetermined transport speed V at which the inspection object P is transported by the article transport unit 10 is set in advance as a part of article type setting information in accordance with the article type of the inspection object P (for example, in accordance with an X-ray transmittance described later) when the article type of the inspection object P is registered. It should be noted that, although the belt conveyor is used here, the inspection object P may be transported by a conveyor of another method.

The X-ray inspection unit 20 of the X-ray inspection apparatus 1 includes an X-ray generator 21 (radiation source) that irradiates the inspection object P passing through an inspection region Z1, which is a predetermined section on the transport path 11a, with the X-rays, and a line sensor type X-ray detector 22 (radiation detection unit) that detects an X-ray amount (hereinafter, referred to as an X-ray transmission amount) transmitted through the inspection object P.

In addition, although the shape is not shown in detail, the X-ray inspection unit 20 forms an article passage space within a predetermined height range on the transport path 11a in a housing installation region Z2, and, in the article passage space, a lead-containing curtain C1 on an entrance side that partitions the inspection region Z1 and a passage space on the entrance side, and a lead-containing curtain C2 on an exit side that partitions the inspection region Z1 and a passage space on the exit side are doubly provided on the entrance side and the exit side of the inspection region Z1, respectively. The lead-containing curtains C1 and C2 on the entrance side and the exit side are noren-style strip curtains that can open and close the entrance and exit of the housing installation region Z2 of the X-ray inspection apparatus 1, and configured by disposing a plurality of flexible X-ray-shielding hanging strips, each supported at its upper end, so as to be adjacent to each other in a Y direction, which is a passage width direction.

The X-ray generator 21 is an X-ray irradiation unit that irradiates the inspection object P, which moves in the inspection region Z1 on the transport path 11a of the article transport unit 10 at the predetermined transport speed V, with the X-rays which are the electromagnetic waves.

The X-ray generator 21 includes, for example, an X-ray tube 21a inside a box 21b made of metal, and has a configuration in which the X-ray tube 21a is immersed in insulating oil (not shown) for cooling inside the box 21b. Although a detailed structure of the X-ray tube 21a will not be described, for example, electrons released from a filament on a cathode side in an outer enclosure are focused by a focusing electrode, the electrons collide with a target on an anode side facing the filament, and the X-rays generated from the target are emitted to the transport path 11a side.

The X-ray tube 21a is disposed, for example, such that a longitudinal direction thereof is substantially parallel to the X direction, and the X-rays generated by the X-ray tube 21a in the X-ray generator 21 are emitted downward from an X-ray window portion 21c on a bottom side of the box 21b and in a direction perpendicular to the transport direction. The anode of the X-ray tube 21a may be a stationary type or a rotating type. Further, the X-ray window portion 21c may have a collimator function of limiting an irradiation field of the X-rays to a predetermined shape.

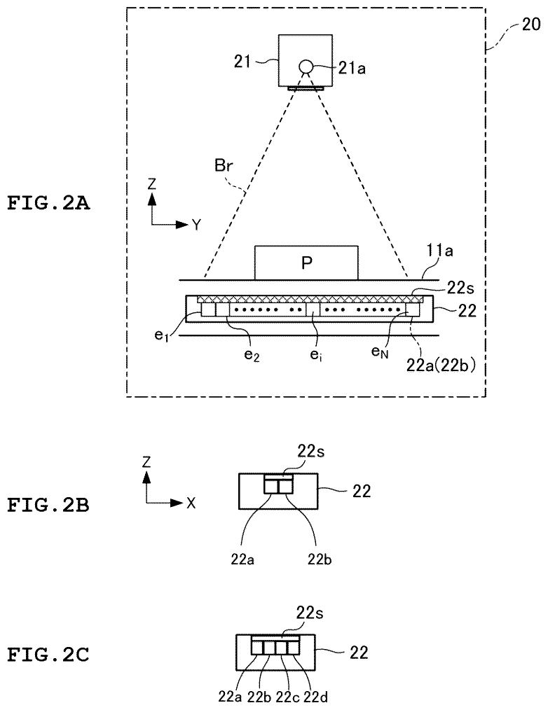

The X-ray generator 21 configured as described above emits an X-ray beam Br having a predetermined beam shape, for example, a fan beam shape indicated by a dashed line in FIG. 1 and FIG. 2A, in a direction perpendicular to the X direction at a predetermined position in the transport direction of the article transport unit 10, irradiates the inspection object P passing through the inspection region Z1 with the X-rays having an irradiation intensity within a predetermined range, and causes the X-rays transmitted through the inspection object P to be incident on the line sensor type X-ray detector 22.

The X-ray detector 22 of the X-ray inspection unit 20 includes detection element arrays 22a and 22b in a plurality of stages, for example, detection element arrays 22a and 22b in at least two stages as shown in FIG. 2B, which are linearly disposed with the Y direction perpendicular to the X direction, which is the transport direction of the inspection object P, as the main scanning direction, and the detection element arrays 22a and 22b in a plurality of stages are disposed in parallel adjacent to each other in the X direction, which is the article transport direction.

In addition, as shown in FIG. 2A, the detection element arrays 22a and 22b in a plurality of stages each include a plurality of X-ray detection elements e₁ to e_{N} adjacent to each other in the Y direction, and a plurality of rows of X-ray detection elements e₁ to e_{N} aligned in the Y direction are aligned and disposed adjacent to each other in the X direction at the detection positions (detection positions of the element numbers). In addition, the X-ray detector 22 is disposed on a lower side of the transport path 11a, which is an inner side of the loop-shaped belt 11 of the article transport unit 10. Here, for example, in a case where each sensor width in the X direction of each of the plurality of X-ray detection elements e₁ to e_{N} is set to 1 mm, a gap between the sensors is set to be small enough to be negligible with respect to the sensor width, and a width in the Y direction, which is a width direction of the transport path 11a for transporting the inspection object P, is set to 200 mm, it is sufficient to use a line sensor having approximately 200 X-ray detection elements e₁ to e_{N} in the detection element array of each stage (hereinafter, referred to as a detection element array 22i of each stage).

The X-ray detector 22 may include the detection element arrays 22a, 22b, and the like in three or more stages, for example, detection element arrays 22a, 22b, 22c, and 22d in four stages as shown in FIG. 2C, or may include the detection element arrays 22a, 22b, and the like in five or more stages. However, in the detection element arrays 22a, 22b, and the like in a plurality of stages, the detection element array 22i of each stage includes the plurality of X-ray detection elements e₁ to e_{N}, and the plurality of rows (plurality of sets) of X-ray detection elements e₁ to e_{N} of the detection element arrays 22a, 22b, and the like in a plurality of stages are aligned and disposed adjacent to each other in the X direction at the detection positions of the element numbers.

The X-ray detector 22 also includes a sheet-like scintillator 22s that is attached to an incident surface side of the detection element arrays 22a and 22b in a plurality of stages and that has good afterglow characteristics, and the detection element arrays 22a, 22b, and the like in a plurality of stages are configured by CMOS type photoelectric sensors that receive light (optical image) emitted in response to the X-rays (X-rays transmitted through the inspection object P) detected by the scintillator 22s with the plurality of X-ray detection elements e₁ to e_{N} in the detection element array 22i of each stage in a predetermined main scanning period, and that sequentially output detection data Lxa and Lxb.

The main scanning of the detection element array 22i of each stage is executed at least once in a predetermined delay time t1 in accordance with a distance d between the detection positions of the plurality of X-ray detection elements e₁ to e_{N} and the transport speed V, and a period of the main scanning is a short time that is equal to or shorter than the predetermined delay time t1 used for the TDI-method imaging data processing.

Here, in a case where the predetermined delay time t1 in accordance with a reference height hc of the inspection object P is calculated based on the reference height hc such as a center height or a centroid height of the inspection object P, the disposition of the detection element arrays 22a and 22b in a plurality of stages of the X-ray generator 21 and the X-ray detector 22 and a distance d between the detection centers thereof, the transport speed V of the article transport unit 10 in accordance with the article type of the inspection object P, a height H1 of the X-ray generation position of the X-ray generator 21 on the transport path 11a, and an X-ray generation height H2 from a detection surface P0 of the detection element arrays 22a, 22b, and the like in a plurality of stages of the X-ray detector 22 to the target of the X-ray generator 21, the predetermined delay time t1 is calculated by the following expression [1].

$$t 1 = \{ ( H 1 - hc ) / H 2 \} \cdot ( d / V ) \qquad [ 1 ]$$

In the following description, for convenience of description, the period (scan period) of the main scanning for scanning the plurality of X-ray detection elements e₁ to e_{N} in the detection element array 22i of each stage will be referred to as a main scanning period t2.

Since the detection element arrays 22a and 22b in a plurality of stages including the CMOS type photoelectric sensors include the element arrangement in which the plurality of sets of X-ray detection elements e₁ to e_{N} are adjacent to each other in the X direction at the detection positions of the element numbers, in a case where each of the plurality of X-ray detection elements e₁ to e_{N} in the detection element array 22i of each stage outputs an electric signal in accordance with the amount of light from the scintillator 22s, the detection data Lxa and Lxb from the plurality of rows of X-ray detection elements e₁ to e_{N} of the detection element arrays 22a and 22b in a plurality of stages have detection timings shifted in accordance with the distance d between the detection positions and the transport speed V, and are data that can be subjected to imaging data processing for integration by the TDI method.

The expression “good afterglow characteristics” means that the light emission amount (brightness) of the scintillator 22s is obtained to the extent (for example, 40% or more of the brightness of the related-art product having a large light emission amount, preferably 60% or more) that the inspection image can be generated with low noise even in a high transport speed range by the TDI-method imaging, and the attenuation time (damping time constant) of the light emission intensity of the scintillator 22s is sufficiently shorter than the scanning period t2 (usually several hundred milliseconds) of the detection element array 22i of each stage of the X-ray detector 22, preferably means that the attenuation time is shorter than the scanning period t2 (for example, in a case where the pixel has a transport direction resolution of 0.2 mm at a transport speed of 80 m/min, the transport time of one pixel in the X direction (sub-scanning direction) is 150 μs (approximately 6.7 kHz), and the scanning time of one scan in the Y direction (main scanning direction) is 150 μs/scan) of the detection element array 22i of each stage of the X-ray detector 22 during high-speed transport, and particularly preferably means that the attenuation time is half or less of the scanning period t2 (for example, in a case where the pixel has a transport direction resolution of 0.2 mm at a transport speed of 80 m/min, 75 μs or less) of the detection element array 22i of each stage of the X-ray detector 22 during high-speed transport.

### Configuration and Function of Control Unit

Although a detailed configuration it not shown in the drawing, for example, the control unit 30 is achieved by a combination of hardware such as a central processing unit (CPU), a random access memory (RAM), or the like, and software such as a program or the like that exerts various functions on the hardware. Here, the hardware may include a field programmable gate array (FPGA), a digital signal processor (DSP), or the like. In addition, the various functions described herein are functions of the following plurality of functional units that perform the acquisition and the output of the detection data from which the X-ray image of the inspection object P can be generated, the generation of the inspection image data, the control of the predetermined inspection processing and the display output, and the like.

As shown in FIG. 1, the control unit 30 includes, as the plurality of functional units that exert the various functions, a detection data output unit 31, a level conversion processing unit 32 (image data adjustment means), an article type control unit 33 (inspection condition detection means), an image generation unit 34, an inspection processing unit 35 (inspection image processing means), a determination unit 36, a deterioration detection unit 37 (inspection condition detection means), and a condition setting unit 38 (height setting means, scanning condition setting means), and is configured to execute the control of the predetermined X-ray inspection and the display output for the inspection object P based on the article type information or various types of detection information set in advance in the article type control unit 33.

Here, the detection data output unit 31 executes the detection operation of detecting by the plurality of X-ray detection elements e₁ to e_{N}, at a predetermined period, the X-rays transmitted through the inspection object P among the X-rays emitted from the X-ray generator 21 toward the inspection object P, that is, the main scanning.

In addition, since the plurality of detection element arrays 22a and 22b in a plurality of stages including the CMOS type photoelectric sensors include the detection element arrangement capable of executing time delay integration (TDI) type imaging data processing, the detection data output unit 31 executes the imaging data processing of integrating the detection data Lxa and Lxb from the detection element arrays 22a and 22b in a plurality of stages by the TDI method using the predetermined delay time t1 in accordance with the distance d between the detection positions of both detection element arrays 22a and 22b and the transport speed V of the inspection object P, and outputs the detection data Lx after the imaging data processing.

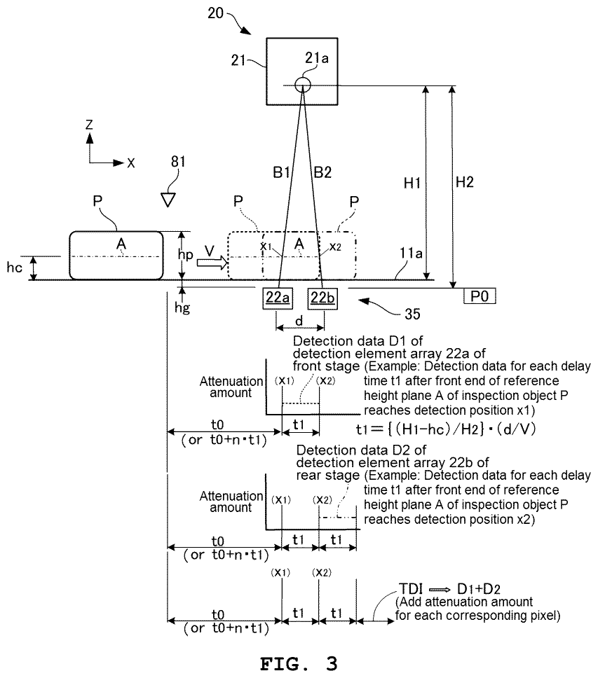

For example, as shown in FIG. 3, in a case where the transport time from when a distal end of the inspection object P is detected by an article detection sensor 81 to when the front end of a reference height plane A of the inspection object P reaches a detection position x1 of the detection element array 22a of the front stage in the drawing is set as a waiting transport time t0 or a waiting transport time t0+n·t1 (n is a natural number corresponding to a multiple of the passage time for the delay time t1 for the detection position x1), the detection data Lxa from the detection element array 22a of the front stage is set as detection data D1 for each delay time t1 after the front end of the reference height plane A of the inspection object P reaches the detection position x1 of the detection element array 22a of the front stage in the drawing, and the detection data Lxb from the detection element array 22b of the rear stage adjacent to the detection element array 22a of the front stage is set as detection data D2 for each delay time t1 after the front end of the reference height plane A of the inspection object P reaches a detection position x2 of the detection element array 22b of the rear stage in the drawing, the imaging data processing is integration processing (TDI→D1+D2 in the drawing) of adding up an image density value corresponding to the amount of X-ray attenuation of the pixel on each main scanning line corresponding to the detection data of each of the detection elements e₁ to e_{N} in the detection data D1 of the front stage side and an image density value corresponding to the amount of X-ray attenuation of the pixel on each main scanning line corresponding to the detection data of each of the detection elements e₁ to e_{N} in the detection data D2 of the rear stage side.

The level conversion processing unit 32 is image data adjustment means for adjusting the detection data Lx output from the detection data output unit 31 so that the image quality of the inspection image generated by the image generation unit 34 is improved, in a case where the establishment of the specific inspection condition is detected by the article type control unit 33 and the deterioration detection unit 37.

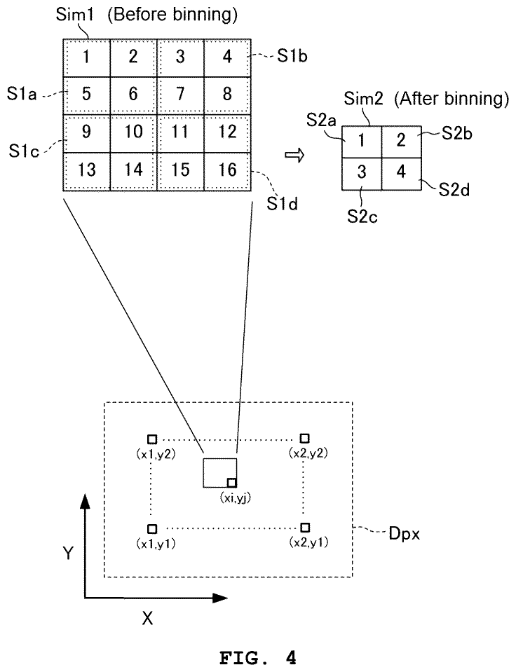

The specific inspection condition is, for example, a condition in which the irradiation intensity of the X-rays from the X-ray generator 21 to the inspection object P is insufficient or a condition in which the irradiation time of the X-rays is insufficient, and the adjustment executed by the level conversion processing unit 32 in a case where the specific inspection condition is established corresponds to processing of expanding a range of the density value of the image, that is, processing of adjusting the brightness of the image in accordance with the exposure amount (irradiation time and irradiation intensity of X-rays), such as gain adjustment of a digital camera, and specifically, for example, can be binning processing or kernel processing (filter processing) as shown in FIG. 4.

The article type control unit 33 has a function of storing the article type setting information, which is set and registered in advance for each article type of the inspection object P, in the memory, variably setting various parameters related to the inspection condition based on the article type setting information (for example, article type number, article name, number, weight, and shape of contents, tube current, tube voltage, transport speed, determination threshold value, mask processing condition, and the like), and controlling the article transport unit 10, the X-ray inspection unit 20, the control unit 30, and the display operation unit 40 to required operation conditions in accordance with the article type.

In addition, the article type control unit 33 has a function of inspection condition detection means for, in a case where the article type selection is performed by the selection operation from the display operation unit 40, specifying the inspection condition based on the setting information of the article type and the inspection condition based on the other types of detection information, and detecting in advance that the specific inspection condition that causes the degradation of the image quality of the inspection image generated by the image generation unit 34 is established, for example, that the transport speed V of the inspection object P passing through the inspection region Z1 on the transport path 11a reaches or exceeds a predetermined speed, or that the X-ray transmittance of the inspection object P in the X-ray transmission direction is within a low transmittance range among a plurality of transmittance ranges set in advance.

The image generation unit 34 generates image data of an inspection image Dpx consisting of a plurality of pixels each having the density value, based on the detection data Lx output from the detection data output unit 31 after the TDI-method imaging data processing in response to the detection signals from the plurality of X-ray detection elements e₁ to e_{N} for each main scanning of the detection element arrays 22a and 22b in a plurality of stages of the X-ray detector 22.

The inspection processing unit 35 executes the predetermined inspection processing of inspecting a predetermined quality of the inspection object P based on the data of the inspection image Dpx of the inspection object P. The predetermined inspection processing here has a function of executing image processing including, specifically, for example, image processing of setting a shading level from a result of logarithmic conversion from a detection signal level in accordance with the sensitivity of the human eye, processing of enhancing and clarifying a steep change in an image density value in the vicinity of a contour of the foreign matter, and detection processing of an edge or a line corresponding to a contour of the foreign matter or a fixed-shaped content, suitable for determination processing or visual confirmation work, for example, in order to automatically determine whether or not there is the contained foreign matter or a missing item in the inspection object P by X-rays and/or visually. It goes without saying that, depending on the required inspection content, the inspection processing unit 35 may have a function of executing image processing suitable for mass inspection, inspection of a shape of the inspection object, such as a thickness, a length, packaging defect detection such as biting of the content into a seal portion, and the like, instead of the inspection image processing for foreign matter detection or missing item inspection.

The determination unit 36 executes a known predetermined determination processing program using main parameters for specifying the determination condition of the X-ray inspection for each article type, for example, a foreign matter detection limit, a foreign matter area ratio, and a shading limit, based on the image data of the inspection object P that has been subjected to the image processing by the inspection processing unit 35, and determines whether or not the quality of the inspection object P is acceptable. For example, the determination unit 36 performs image processing suitable for determination processing on the inspection image, and then determines the presence or absence of the contained metal foreign matter and the like having a high X-ray absorption rate by comparing the X-ray absorption rate with a predetermined threshold value, and sequentially outputs the determination result to a touch panel screen of the display operation unit 40.

The deterioration detection unit 37 has a deterioration detection function for detecting a predetermined deterioration state of the X-ray generator 21 and the X-ray detector 22, and supplies deterioration detection information as the detection information to the article type control unit 33 that is the inspection condition detection means. That is, the deterioration detection unit 37 has a function of inspection condition detection means for specifying the inspection condition based on the article type setting information and the inspection condition based on the other types of detection information at the time of the article type selection, and detecting in advance the establishment of the specific inspection condition that causes the degradation of the image quality of the inspection image generated by the image generation unit 34 at the time of the article type selection, in cooperation with the article type control unit 33.

Further, the deterioration detection unit 37 can estimate and calculate a degree of vacuum of the X-ray tube 21a that deteriorates over time, and has a function of estimating and calculating the remaining life or the degree of deterioration of the X-ray tube 21a based on the calculated value of the degree of vacuum. The function of measuring the degree of vacuum of the X-ray tube 21a and estimating and calculating the remaining life is the same as the function disclosed in WO2019/117172A as an X-ray generation device using the principle of an ionization vacuum gauge, for example, and it is possible to determine, from the remaining life, whether or not the X-ray irradiation intensity is decreased to be less than the predetermined intensity due to the deterioration of the X-ray tube 21a over time, and reaches a degree that may induce degradation of the image quality of the inspection image.

That is, the specific inspection condition may include a condition in which the transport speed of the inspection object passing through the inspection region Z1 on the transport path 11a reaches or exceeds a predetermined speed, or a condition in which the irradiation intensity of the X-rays emitted from the X-ray generator 21 to the inspection object P is decreased to be less than a predetermined intensity, or may include a condition in which the transmittance of the inspection object P in the transmission direction of the X-rays is within a low transmittance range among the plurality of transmittance ranges set in advance, or a condition in which a significant decrease state of the detection sensitivity of the X-ray detector 22 is detected.

In addition, the above-described specific inspection condition may be set stepwise such that the specific inspection condition is established in a case where any one of a first specific transport condition in which the transport speed of the inspection object P passing through the inspection region Z1 on the transport path 11a of the article transport unit 10 is equal to or higher than a first transport speed (for example, 40 m/min) equal to a predetermined speed that is relatively higher than a normal transport speed in the same type of the article and is less than a second transport speed (for example, 90 m/min) that is higher than the first transport speed and a second specific transport condition in which the transport speed of the inspection object P is in a high transport speed range equal to or higher than the second transport speed is established.

It is also conceivable that the level conversion processing unit 32 changes the processing function of adjusting the detection data of the inspection object P so that the adjustment amount of the detection data of the inspection object P is larger in a case where the article type control unit 33 and/or the deterioration detection unit 37 detects that the second specific transport condition is set than in a case where the article type control unit 33 and/or the deterioration detection unit 37 detects that the first specific transport condition is set.

Specifically, in a case where the X-ray image Dpx of a part or the whole of the inspection object P can be generated by the detection data Lx output from the detection data output unit 31, and a certain segment image Sim1 corresponding to a predetermined number of adjacent pixel groups in the X-ray image Dpx is obtained, the level conversion processing unit 32 usually executes predetermined binning processing in accordance with the detection information of the article type control unit 33 and/or the deterioration detection unit 37, which are the inspection condition detection means, as shown in FIG. 4.

In this case, when the segment image Sim1 is divided into a plurality of sub-segment regions S1a, S1b, S1c, and S1d (small regions) by bin division, the level conversion processing unit 32 executes the binning processing of using, as processing units, the plurality of pixel values (in FIG. 3, for example, pixel values inside the upper left sub-segment region S1a in the segment image Sim1 before the binning are shown by being substituted with “1”, “2”, “5”, and “6” representing the pixel positions) corresponding to the density values (charges of the detection signals) inside each small region and integrating the plurality of pixel values into the pixel value (in the same drawing, for example, an upper left pixel value on a segment image Sim2 after the binning is shown by being substituted with “1” representing the pixel position) corresponding to one density value for each processing. In this manner, the level conversion processing unit 32 has a function of improving the signal-to-noise ratio (S/N) and increasing the image processing speed by reducing the size of the inspection image while adjusting the pixel value data corresponding to the density value of the X-ray image data of the inspection object P to a side for improving the image quality of the inspection image.

The binning processing here may be processing of integrating the plurality of pixel values corresponding to the plurality of density values in each small region subjected to the bin division into one added pixel value, or may be processing of integrating the plurality of pixel values into one average pixel value. In the former case, the same advantageous effect as the advantageous effect of improving the signal-to-noise ratio (S/N) by increasing the signal level of the detection signal of the X-ray detector 22 is obtained, and, in the latter case, the same advantageous effect as the advantageous effect of improving the signal-to-noise ratio (S/N) by reducing the noise components is obtained.

Here, the processing of adjusting the detection data is described as the binning processing that is a suitable example, but the kernel processing (filter processing with a predetermined kernel size) for density conversion or the like that can contribute to the improvement in the signal-to-noise ratio (S/N) such as expanding the dynamic range of the density value of the inspection image can also be executed.

In addition, the level conversion processing unit 32 executes the binning processing for providing respectively different adjustment amounts by setting the bin division size to 2×2 as shown in FIG. 4 when the article type control unit 33 detects that the first specific transport condition is set from the setting value of the transport speed V included in the article type information of the inspection object P by the article transport unit 10, and setting the bin division size to 4×4 when the article type control unit 33 detects that the second specific transport condition is set.

Therefore, the level conversion processing unit 32 executes the binning processing in each specific transport condition such that the adjustment amount for adjusting the image data of the inspection object P obtained by the detection data from the detection data output unit 31 is larger in a case where the article type control unit 33 detects that the second specific transport condition is set than in a case where the article type control unit 33 detects that the first specific transport condition is set.

In addition, as shown in FIG. 4, in a case where the transport speed V of the inspection object P passing through the inspection region Z1 on the transport path 11a of the article transport unit 10 is in a normal transport speed range of the same type of the article, for example, less than 40 m/min, and the establishment of the specific inspection condition is not detected by the article type control unit 33, the level conversion processing unit 32 sets the bin division size to 1×1 and does not execute the effective binning processing.

In addition to the data adjustment by the level conversion processing unit 32 as described above, the article type control unit 33 may control the tube voltage of the X-ray tube 21a, which is the X-ray irradiation condition of the X-ray generator 21, to different voltage values between a case where the transport speed V of the inspection object P passing through the inspection region Z1 on the transport path 11a of the article transport unit 10 is on a lower side (for example, 10 to 19 (m/min)) in the normal transport speed range of the same type of the article and a case where the transport speed V is on a higher side (for example, 20 to 39 (m/min)) in the normal transport speed range.

In addition, even in a case where it is determined that the specific inspection condition is established, regardless of whether the first specific transport condition in which the transport speed of the inspection object P passing through the inspection region Z1 on the transport path 11a of the article transport unit 10 is equal to or higher than the first transport speed (for example, 40 m/min) and lower than the second transport speed (for example, 90 m/min) is set, or the second specific transport condition in which the transport speed of the inspection object P passing through the inspection region Z1 on the transport path 11a of the article transport unit 10 is equal to or higher than the second transport speed is set, even though the setting conditions of the tube voltage of the X-ray tube 21a of the X-ray generator 21 are the same, the article type control unit 33 may control the tube voltage of the X-ray tube 21a, which is the X-ray irradiation condition of the X-ray generator 21, to different voltage values between a case where the transport speed of the inspection object P passing through the inspection region Z1 on the transport path 11a of the article transport unit 10 is on a lower side (for example, 40 to 49 (m/min) or 90 to 99 (m/min)) in the speed range of each specific transport condition and a case where the transport speed of the inspection object P passing through the inspection region Z1 on the transport path 11a of the article transport unit 10 is on a higher side (for example, 50 to 89 (m/min) or 100 or higher (m/min)) in the speed range of each specific transport condition.

That is, the article type control unit 33 can be configured to control the tube voltage of the X-ray tube 21a to a voltage value different from that of other transport speed ranges in a specific transport speed range before or after switching between the first specific transport condition and the second specific transport condition.

The X-ray generator 21 can emit the X-rays having a relatively short wavelength and a relatively strong transmission power in a case where the tube voltage of the X-ray tube 21a is increased, and can emit the X-rays having a relatively long wavelength and a relatively weak transmission power in a case where the tube voltage is decreased.

Therefore, the level conversion processing unit 32 and the article type control unit 33 have a function of improving the signal-to-noise ratio (S/N) by variably setting the tube voltage of the X-ray tube 21a, which is the X-ray irradiation condition of the X-ray generator 21, in addition to reducing the inspection image size while adjusting the pixel value data corresponding to the density value of the X-ray image data of the inspection object P to a side on which the image quality of the inspection image is improved, by the binning processing via the level conversion processing unit 32 by variably setting the tube voltage of the X-ray tube 21a, which is the X-ray irradiation condition of the X-ray generator 21.

The display operation unit 40 includes a flat panel display through which request information can be input to the control unit 30 in response to an operation input or an article type list or article type setting information set and stored in the article type control unit 33 can be displayed on a screen.

The control unit 30 further includes a condition setting unit 38 that exerts a function of height setting means for setting the reference height hc from the transport surface of the transport path 11a and a function of scanning condition setting means for setting the scan period in the main scanning direction (Y direction) of the X-ray detector 22 and the delay time t1 in the transport direction (X direction) so that the aspect ratio on the transmission image at the reference height hc becomes 1, in cooperation with the display operation unit 40. The condition setting unit 38 includes a memory 38a as storage means for storing the reference height set for each article type by the function as the height setting means.

### Effects

Next, the operations of the present embodiment will be described.

In the X-ray inspection apparatus 1 according to the present embodiment configured as described above, first, the article type registration or the like of the inspection object P is performed before the inspection, and at the time of the article type registration, the reference height hc of the X-ray inspection is input from the display operation unit 40 or a touch panel of another information terminal connected to the display operation unit 40 via data communication.

Specifically, in a case where a height hp of the inspection object P is input from an input interface mounted in the display operation unit 40 at the time of the article type registration of the inspection object P or is measured by an inspection object height measurement sensor (not shown) the reference height hc of the X-ray inspection is calculated based on the height hp of the inspection object P. The reference height hc is calculated by the following expression [2] by default.

$$hc = h p / 2 \qquad [ 2 ]$$

In addition, the detection data output unit 31 having a delay time calculation function calculates the delay time t1 corresponding to the reference height hc at which the inspection is desired, based on a calculation result of the reference height hc, the disposition of the detection element arrays 22a and 22b in a plurality of stages of the X-ray generator 21 and the X-ray detector 22, and the transport speed V of the article transport unit 10 in accordance with the article type of the inspection object P.

During the inspection, the control function of the control unit 30 causes the article transport unit 10 to operate, the inspection object P is transported at the predetermined transport speed V, the inspection object P passing through the inspection region Z1 is irradiated with the X-rays from the X-ray generator 21 with the irradiation intensity set in advance in accordance with the article type of the inspection object P, and the X-rays transmitted through the inspection object P are detected by the X-ray detector 22.

During this inspection, in the control unit 30, the detection data Lxa and Lxb of the detection element arrays 22a and 22b in a plurality of stages output from the X-ray detector 22 are first temporarily stored in a work memory in the detection data output unit 31. In addition, synthesis processing by the integration of the detection data Lxa and Lxb in the TDI method is executed so that the detection timing of the inspection object P by the detection element arrays 22a and 22b of two adjacent stages (any two adjacent front and rear stages) is matched between the respective pairs of X-ray detection elements adjacent to each other in the article transport direction, using the calculated delay time t1, so that the detection data Lx corresponding to the reference height hc is acquired.

As described above, in the present embodiment, the optical image emitted from the scintillator 22s of the X-ray detector 22, which detects the X-rays and has good afterglow characteristics, is photoelectrically converted by the CMOS type photoelectric sensor, the detection data Lxa and Lxb of the detection element arrays 22a and 22b (line sensors) in a plurality of stages of the X-ray detector 22 are obtained, the detection data Lxa and Lxb are integrated by the TDI method to obtain the imaging data Lx, and the inspection image Dpx is generated based on the imaging data Lx.

When the inspection image Dpx is generated, the blurriness of the inspection image obtained from the imaging data of the detection element arrays 22a and 22b in a plurality of stages is effectively suppressed by the action of the scintillator 22s having good afterglow characteristics in which a predetermined light emission amount is obtained within a time of ½ or 1/k (k is a natural number) of the delay time t1, which is the scanning period of the detection element array 22i of each stage of the X-ray detector 22, and the afterglow characteristics are shortened to the extent that the afterglow does not overlap with the detection signal of the next period of the detection element array 22i of each stage.

Therefore, in addition to the generation of the inspection image with low noise even in a high transport speed range by the TDI-method imaging in which the CMOS sensor is adopted, the blurriness of the X-ray image Dpx is effectively suppressed by the improvement in the temporal resolution of the scintillation light, and the required detection sensitivity is ensured.

Then, after the predetermined inspection processing is executed by the inspection processing unit 35 based on the image data of the inspection image Dpx in which the required detection sensitivity is ensured, the determination processing for the X-ray inspection is executed by the determination unit 36.

In the present embodiment, the article type control unit 33 and the deterioration detection unit 37 detect that the specific inspection condition that causes the degradation of the image quality of the inspection image Dpx is established, and the level conversion processing unit 32 adjusts the detection data Lx output from the detection data output unit 31 so that the image quality of the inspection image Dpx is improved, at the time of the detection, so that the image generation unit 34 can generate the inspection image Dpx in which the range of the density value is expanded, and the inspection processing unit 35 can execute the accurate inspection processing based on the data of the inspection image Dpx with the expanded range of the density value.

That is, by expanding the range of the density value of the inspection image Dpx by the binning processing or the kernel processing, it is possible to execute image reduction with suppressed information omission due to thinning out of the pixels, and even in a case where the article transport speed V is increased or the outputs of the X-ray generator 21 are reduced, the influence of the decrease in the signal level of the X-ray detection signal can be more effectively suppressed, and satisfactory inspection processing can be executed.

Further, in the present embodiment, the specific inspection condition includes a condition in which the transport speed V of the inspection object P passing through the predetermined section on the transport path 11a reaches or exceeds the predetermined speed, or a condition in which the irradiation intensity of the X-rays emitted from the X-ray generator 21 to the inspection object P is decreased to be less than the predetermined intensity. Therefore, in a case where the specific inspection condition causes the degradation of the image quality of the inspection image Dpx, in addition to the TDI-method imaging data processing, the detection data Lxa and Lxb output from the X-ray detector 22 is adjusted by the level conversion processing unit 32 so that the image quality of the inspection image Dpx is improved. Therefore, a required image quality of the inspection image DPx can be ensured, and the satisfactory inspection processing can be executed.

In addition, in the present embodiment, the scan period in the main scanning direction of the X-ray detector 22 and the delay time t1 for the TDI-method integration processing are variably set so that the aspect ratio on the transmission image at the reference height hc becomes 1. Therefore, the resolution in the X and Y directions, which are the respective coordinate axis directions of the two-dimensional inspection image Dpx, is uniformly obtained, and the effect of the time delay integration (TDI) method is accurately obtained.

In the present embodiment, in a case where the reference height hc set by the height setting means is stored for each article type, a suitable height can be set by setting a suitable reference height hc, for example, the center height or the centroid height for each article type, and the time taken for each portion of the reference height plane A of the reference height hc to pass between the detection element array 22a on the front stage side and the detection element array 22b on the rear stage side that are adjacent in the transport direction the delay time t1 in the transport direction for the TDI-method integration processing.

In addition, in the present embodiment, a configuration can also be adopted in which a warning is output in a case where a transport disturbance, which leads to the degradation of the image quality of the inspection image Dpx, occurs due to, for example, the influence of the lead-containing curtains C1 and C2 on the entrance side and the exit side. In this case, as means for detecting the transport disturbance, a workpiece width in the transport direction on the transmission image, that is, a length of the inspection object P in the X direction can be measured, or the transport deflection or a change in the transport load corresponding to the transport deflection can be monitored based on the output pulse of the encoder E of the transport drive motor M or based on the change in the current of the transport drive motor M.

In addition, in the present embodiment, or in order to suppress the insufficient X-ray amount in the high transport speed range, it is also considered to increase the tube voltage of the X-ray tube 21a of the X-ray generator 21 from the tube voltage in the normal transport speed range. It goes without saying that the transport speed and the tube voltage of the X-ray tube can be variably set in accordance with the article type of the inspection object P.

According to the present embodiment, it is possible to provide the X-ray inspection apparatus that can execute satisfactory inspection while ensuring the required detection sensitivity in the TDI-method X-ray detector while increasing the article transport speed and reducing the outputs of the X-ray generator.

It should be noted that, here, the X-ray detector 22 is described as a plurality of line sensors such as the detection element arrays 22a, 22b, and the like in a plurality of stages, but the X-ray detector 22 may be an area sensor of a CMOS sensor type in which the detection element arrays 22a, 22b, and the like in a plurality of stages are configured in multiple stages, and the imaging data processing of integrating the detection data of the detection element arrays 22a, 22b, and the like in a plurality of stages located front and rear in the transport direction in the area sensor may be performed by the TDI method.

As described above, the X-ray inspection apparatus according to the embodiment of the present invention can execute the satisfactory inspection by effectively suppressing the influence of the decrease in the detection signal level of the line sensor type X-ray detector in the high transport speed range or the like which is the specific inspection condition, while increasing the article transport speed and reducing the outputs of the X-ray generator. The present invention is useful for a general X-ray inspection apparatus that acquires image data in accordance with an amount distribution of X-rays transmitted through a transport article by a periodic detection operation of a line sensor type X-ray detector and that inspects a quality of an inspection object based on the image data.

### DESCRIPTION OF REFERENCE NUMERALS AND SIGNS

1 X-ray inspection apparatus
10 Article transport unit
11 Belt
11a Transport path
12, 13 Roller
20 X-ray inspection unit
21 X-ray generator
21a X-ray tube
21b Box
21c X-ray window portion
22 X-ray detector (line sensor)
22a, 22b Detection element arrays (detection element arrays in plurality of stages, line sensors in plurality of stages, CMOS type photoelectric sensors)
22c, 22d Detection element arrays (detection element arrays in plurality of stages, line sensors in plurality of stages, CMOS type photoelectric sensors)
22i Detection element array of each stage (line sensor of each stage, CMOS type photoelectric sensor)
22s Scintillator
30 Control unit
31 Detection data output unit (TDI-method imaging data processing unit)
32 Level conversion processing unit (image data adjustment means)
33 Article type control unit
34 Image generation unit
35 Inspection processing unit
36 Determination unit
37 Deterioration detection unit (inspection condition detection means)
38 Condition setting unit (height setting means, scanning condition setting means)
38a Memory (storage means)
40 Display operation unit (height setting means, scanning condition setting means)
C1, C2 Curtain (lead-containing shielding curtain)
Dpx inspection image (image data of inspection image)
e1 to eN Plurality of X-ray detection elements (detection elements)
Lx Detection data (TDI-synthesized detection data, light reception data)
Lxa, Lxb Detection data
P Inspection object
S1a, S1b, S1c, S1d Sub-segment region
Sim1 Segment image (segment image before binning)
Sim2 Segment image (segment image after binning; data of inspection image with expanded range of density value)
t1 Delay time
t2 Scanning period (scan period of line sensor)
X Transport direction (X direction, sub-scanning direction)
Y Main scanning direction (Y direction, transport path width direction)
Z1 Inspection region (predetermined section)
Z2 Housing installation region
(xi, yj) Pixel (coordinate component of pixel)

What is claimed is:

1. An X-ray inspection apparatus comprising:
an X-ray generator that irradiates an inspection object passing through a transport path with X-rays;
an X-ray detector that includes a plurality of line sensors arranged in a transport direction of the inspection object and each including a plurality of detection elements linearly disposed in a main scanning direction perpendicular to the transport direction and that outputs detection data obtained from each detection element for each stage of the plurality of line sensors;
an image generation unit that generates an inspection image including a plurality of pixels each having a density value based on the detection data output by the X-ray detector; and
an inspection processing unit that inspects a quality of the inspection object based on the inspection image,
wherein the X-ray detector includes a scintillator that detects the X-rays and that has good afterglow characteristics,
the plurality of detection elements are CMOS type photoelectric sensors that output the detection data by receiving light emitted in response to the X-rays detected by the scintillator, and
the image generation unit generates the inspection image based on light reception data obtained by integrating the detection data of the plurality of line sensors by a TDI method.

2. The X-ray inspection apparatus according to claim 1, further comprising:
inspection condition detection means for detecting that a specific inspection condition that causes degradation in an image quality of the inspection image is established; and
image data adjustment means for adjusting the detection data output from the X-ray detector so that the image quality of the inspection image is improved, in a case where the inspection condition detection means detects that the specific inspection condition is established,
wherein the image generation unit generates an inspection image with an expanded range of the density value based on adjusted detection data that is adjusted by the image data adjustment means, and
the inspection processing unit executes the inspection based on data of the inspection image with the expanded range of the density value.

3. The X-ray inspection apparatus according to claim 2,
wherein the specific inspection condition includes a condition in which a transport speed of the inspection object passing through a predetermined section on the transport path reaches or exceeds a predetermined speed, or a condition in which an irradiation intensity of the X-rays emitted from the X-ray generator to the inspection object is decreased to be less than a predetermined intensity.

4. The X-ray inspection apparatus according to claim 1, further comprising:
height setting means for setting a reference height from a transport surface of the transport path; and
scanning condition setting means for setting a scan period in the main scanning direction of the X-ray detector and a delay time in the transport direction so that an aspect ratio on a transmission image at the reference height becomes 1.

5. The X-ray inspection apparatus according to claim 4, further comprising:
storage means for storing the reference height set by the height setting means for each article type of the inspection object.

6. The X-ray inspection apparatus according to claim 2, further comprising:
height setting means for setting a reference height from a transport surface of the transport path; and
scanning condition setting means for setting a scan period in the main scanning direction of the X-ray detector and a delay time in the transport direction so that an aspect ratio on a transmission image at the reference height becomes 1.

7. The X-ray inspection apparatus according to claim 6, further comprising:
storage means for storing the reference height set by the height setting means for each article type of the inspection object.
